(19) United States
(12) Patent Application Publication
(10) Pub. No.: US 2002/0033583 A1
(43) Pub. Date: Mar. 21, 2002

(54) Golf bag

(76) Inventors: Barbara Engelhardt, Gruibingen (DE); Michael Engelhardt, Gruibingen (DE)

Correspondence Address: McGLEW AND TUTTLE, P.C., SCARBOROUGH STATION, SCARBOROUGH, NEW YORK, NY, 10510-0827, US

(21) Appl. No.: 09/950,594

(22) Filed: Sep. 12, 2001

(30) Foreign Application Priority Data
Sep. 17, 2000 (DE) 200 17 948.9

(51) Int. Cl. B62B 1/00

(52) U.S. Cl. 280/47.26; 280/47.131

(57) ABSTRACT

A golf bag includes a bottom part, a cylinder part with stabilizing longitudinal webs, a head part, a support device with toggle lever mechanism or another mechanism and a clamping system for folding out and folding in support legs, a pull-out grip and a belt system. The golf bag combines in itself all components for stable standing, rolling, sloped support, carrying on the shoulder or on the back and for transport in the lying or upright position without additional actions on the part of the golfer. The golf bag is easy to handle and can be transported in a compact manner. The golf bag includes a cylinder part (2) provided with a belt system (8), which is connected in a repeatedly detachable manner to a rollable bottom part (1) tiltable in the direction of travel, on the one hand, and to a head part (4) equipped with a pull-out grip (7) and with a support device (5) by means of a plurality of stabilizing longitudinal webs (3) and (3′), wherein the properties of the golf bag are guaranteed by wheels (9) on the bottom part (1) and a support device (5) on the head part (4) and the lightweight design and ability to be disassembled.

### FIELD OF THE INVENTION

The present invention pertains to a golf bag, comprising a bottom part, a cylinder part with stabilizing longitudinal webs, a head part, a support device with a toggle lever mechanism or another mechanism and a clamping system for folding out and folding in support legs and with a pull-out grip as well as with a belt system, which combines in itself all components for stable standing, for rolling, for sloped support for carrying on the shoulder or on the back and for transport in the lying or upright position without additional actions on the part of the golfer.

### BACKGROUND OF THE INVENTION

Many different embodiments of golf bags with various advantages have been known. For example, golfbags have been known which are to be carried on the shoulder with a belt and tilt over easily or are labile on standing when put down on the ground. Attempts are made to overcome this shortcoming by means of stabilizing parts in the body of the golf bag, as a result of which the bags have a considerable weight.

A double belt system for golf bags, which makes it possible to pickup the golf bag like a backpack over the back, has also been known from EP 0461243 B1. However, the belt system is suitable only for carrying the golf bag and does not make it possible in itself either to roll the bag over the golf course or to put it down in a suitable position.

There are also golf bags that have a support device which is released by means of a lever mechanism at the head part. The support legs arranged outside on the golf bag must be folded out and folded in and transported on the shoulder each time there is a change in place. These golf bags cannot be rolled, either.

A support device has also been known from DE 43 27 289 C2 in which the support legs are folded in automatically by taking up the belts and they are folded out again on relieving the belts during a change in place. The folding in and out of the support legs is triggered in this support device by a folding mechanism arranged on the bottom part of the golf bag. When the golf bag is put down, the folding mechanism is pressed onto the bottom of the bag, as a result of which the support legs fold out. When the golf bag is picked up, the folding mechanism is released from the bottom and the support legs are again in contact with the golf bag. This technique is delicate and leads to increased weight of the golf bag due to the necessary structure. With both of these support devices, the golf bags must be carried on the shoulder, which may be difficult especially for elderly golfers.

To eliminate this problem, various chassis or carts have been developed, on which the golf bags can be transported. These off-road vehicles are heavy and bulky. For transportation in the automobile, they require complicated packaging operations and a considerable amount of space beside the golf bag, e.g., in the trunk of an automobile.

A golf bag with an off-road chassis integrated with the golf bag and with a pull-out grip has also been known from WO 97/29809. The design requires much time for assembly and taking apart, considerable skill and has a heavy weight, which is again problematic during loading and unloading in and from an automobile.

### SUMMARY AND OBJECTS OF THE INVENTION

The object of the present invention is therefore to develop a golf bag which combines in itself all the properties for stable standing, rolling, sloped support, carrying on the shoulder or on the back and for transportation in the lying or upright position as needed without additional actions on the part of the golfer, is easy to handle, can be transported in a compact form and eliminates the above-described drawbacks of the state of the art.

According to the invention, a golf bag is provided with a cylinder part, which is in turn detachably connected to a rollable bottom part, on the one hand, and to a head part, on the other hand. This construction makes possible easy assembly and easy disassembly due to a screw connection. Due to the parts of the golf bag being screwed together, the golf bag becomes able to be repaired, which saves time in the case of the replacement of individual worn or defective parts of the golf bag and above all saves costs.

The dimensionally stable bottom part of the golf bag has off-road wheels and occasionally additionally a support foot, which guarantee the easy rolling of the golfbag in case of change of place and its putting down vertically in a stable manner entirely without additional actions together with the pull-out grip arranged at the head part of the golf bag. Furthermore, a support device arranged at the head part makes it possible to put down the golf bag in a sloped position, where the releasing of the support device by the belt system arranged on the cylinder part of the golf bag or by another release mechanism makes it possible to eliminate the need for additional actions for folding in the support legs. Thus, the golf bag according to the present invention makes it possible to put down the golf bag in a vertical position, to roll it in case of a change of place, to put it down in a sloped position, and to carry it on the shoulder or on the back or to transport it in a lying or upright position as needed, without the user having to perform any essential manual actions to release the individual components, which in turn guarantees the easy handling of the golf bag.

The bottom part of the golf bag according to the present may comprise a low-weight, wear-resistant and dimensionally stable one-piece container. This leads to a low weight of the golf bag despite all the techniques available in the area of golf bags and despite the versatile use of the golf bag. The shaping of the bottom part with a base designed in a stepped manner to the longitudinal axis of the golf bag and with wheel cases integrated into the jacket surface creates the conditions for the wheels being essentially covered and protected by the wheel cases and for the tiltability of the bottom part being guaranteed. Even though the wheels project beyond the jacket surface in the case of a jacket surface made in one piece cylindrically without wheel cases, the bottom part of the golf bag can thus be manufactured in an even more inexpensive design. The base of the bottom part may also be beveled in order to make it possible to arrange beside the wheels other support devices, even prior-art ones, with a tilting bottom and support legs, in which the support legs can be released by the tilting bottom.

Furthermore, the fixing points arranged on the inner base of the bottom part guarantee the fastening of lightweight longitudinal webs and their guiding within the cylinder part to connect the bottom part to the head part of the golf bag, and the mounting openings arranged on the jacket surface of the bottom part support the detachable screw connection of the bottom part to the cylinder part.

An arrangement of low-wear off-road wheels with low liability to malfunction is of great advantage. If necessary, the wheels may be fastened to the bottom part by means of a continuous, non-co-rotating axle or floating axles such that their wheel axles extend next to the bottom part in the case of a cylindrical bottom part or are essentially covered and protected by the wheel cases in the case of integrated wheel cases. This offers the advantage that one cannot be caught by the wheels either during rolling or carrying on the shoulder or on the back because they are integrated within the jacket surface of the entire golf bag nearly seamlessly and form a flat unit with the golf bag. Moreover, the eccentric arrangement of the wheel axles relative to the base of the bottom part makes it possible to tilt the golf bag during rolling and to put it down vertically in a stable manner with a three-point bearing despite the tiltability with the base bent in a stepped manner along with the support foot made in one piece with the outer base. Besides the wheels, a beveled base makes possible the arrangement of other, even prior-art support devices with tilting bottom and support legs in which the support legs can be released by the tilting bottom, but this does not guarantee vertical stability.

Also advantageous is the provision of a cylinder part of the golf bag which essentially consists of a flexible material and can be detachably connected to the bottom part and the head part by mounting openings arranged on the open front sides by means of fastening elements such as screws and threaded sleeves, where the cylinder part covers the head part at the same time. The inner outfitting of the cylinder part with coaxial stabilizing strips and loops makes possible the loose guiding of longitudinal webs to stabilize the cylinder part and the distribution of the acting forces during transport of the filled golf bag by the belt among the longitudinal webs. The belt system arranged on the outer jacket surface, which is hung on rings arranged at selectably spaced locations on the cylinder part, on the one hand, and on a toggle lever mechanism arranged at the head part for a support device, on the other hand, makes it possible to carry the golf bag on the shoulder or on the back and to automatically fold in the opened support feet of the support device.

In addition, longitudinal webs which stabilize the cylinder part and essentially consist of a light-weight hollow section, guarantee the lightweight connection of all components of the golf bag from the bottom part to the head part over the cylinder part. One of the longitudinal webs is reinforced by an additional inner tube in order to make allowance for the load requirements imposed by the weight of the golf bag, especially when filled. In addition, the reinforced longitudinal web makes it possible to hold and guide the pull-out grip.

Furthermore, the head part of the golf bag according to the present invention may be a closed material band which is lightweight in itself and is equipped with a mounting surface on its outer jacket surface and with a bracket on the opposite side for the support legs, which are directed toward the bottom part axially to the longitudinal axis of the golf bag. This head part guarantees the connection to the cylinder part and to the bottom part via the stabilizing longitudinal webs, to the pull-out grip and to the support device. The mounting surface and the bracket on the head part make it possible, on the one hand, to arrange the toggle lever mechanism or another mechanism and the clamping system of the support device and its handling as well as of the stabilizing webs. On the other hand, the mounting surface makes possible a stable connection to the reinforced longitudinal web from the bottom part to the head part and the arrangement and the handling of the pull-out grip with the double tube system. The mounting openings present in addition to this on the band material make it possible to cover the head part with the cylinder part and to detachably connect same to the head part by means of fastening elements such as screws or snap fasteners. The essential advantage of this head part design is its high level of functionality in conjunction with a low weight.

The webs arranged horizontally in the head part to stabilize the material band and to protect the clamping system, especially in the case of a load caused by the toggle lever mechanism of the support device, should be pointed out in particular. These webs may be arranged such that they horizontally form a triangular hollow space open on all sides. This hollow space makes it possible to accommodate the clamping system of the support device and ensures its trouble-free function. In addition, the webs, including the clamping system, can be closed by a piece of material such that reaching into the clamping system with the hand or destruction of the clamping system due to the penetration of foreign objects is ruled out.

Additional webs may be arranged in the head part at right angles to the stabilizing webs to form compartments for the separate storage of the golf clubs in the golf bag and support the simple handling of the bag by easy removal or introduction of the golf clubs during the game. In addition, the screws may be used to mount them on the band material of the head part make it possible to accommodate snap fasteners for the detachable fastening of a closing hood after the end of the game.

The functionality of the golf bag according to the present invention is supported especially advantageously by a grip, which may be a pull-out grip. This grip is arranged on the mounting surface of the head part by means of a double tube system and guided on the reinforced longitudinal web such that the grip can be pulled out beyond the center of gravity of the golf clubs being stored in the golf bag during the rolling of the golf bag, as a result of which a considerable reduction in weight is guaranteed for the user. In addition, the double tube system prevents the grip from being pulled completely out of its mount and especially from being jammed during the pushing in of the grip. In addition, the grip holder sloped in relation to the longitudinal axis of the golf bag facilitates handling. The belt system is also advantageous. The optional possibility of fastening to the rings on the cylinder part, which rings are arranged at different distances, on the one hand, and to the toggle lever mechanism of the support device, on the other hand, makes it possible to lift the golf bag with the belt system with the folded-out support feet of the support device folded in automatically at the same time. As a result of this undisturbed carrying of the golf bag on the shoulder or on the back is guaranteed without additional actions on the part of the player.

Finally, the simple lightweight design as well as the materials used and the nondestructively detachable connections between the individual components of the golf bag, as well as the combination of the various possibilities of handling, such as rolling, supporting in a sloped position, standing up vertically and carrying on the back or on the shoulder and easy handling, make possible the easy and compact transport, which may also be versatile as needed, during a change in place as well as during storage and, due to the detachable connections, the repair of the golf bag.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a side view of the complete golf bag according to the present invention standing upright;

FIG. 2 is a top view of FIG. 1;

FIG. 3 is sectional view along line A-A from FIG. 2;

FIG. 4 is a side view of the mounted golf bag frame without cover,

FIG. 5 is a front view of the golf bag of FIG. 4;

FIG. 6 is a side view of the golf bag of FIG. 4 in a sloped position with the support legs folded out;

FIG. 7 is a side view of the golf bag of FIG. 4 in a sloped position with the grip pulled out and the support legs folded in;

FIG. 8 is a top view of the golf bag of FIG. 4;

FIG. 9 is a side view of the head part of the golf bag without cover and the grip pushed in and the double tube system for holding same;

FIG. 10 is a sectional view along line B-B through FIG. 9 with the front view of the double tube system;

FIG. 11 is a side view of the bottom part of the golf bag with wheels and support foot; and

FIG. 12 is a top view of the golf bag of FIG. 11.

### DESCRIPTION OF THE PREFERRED EMBODIMENT

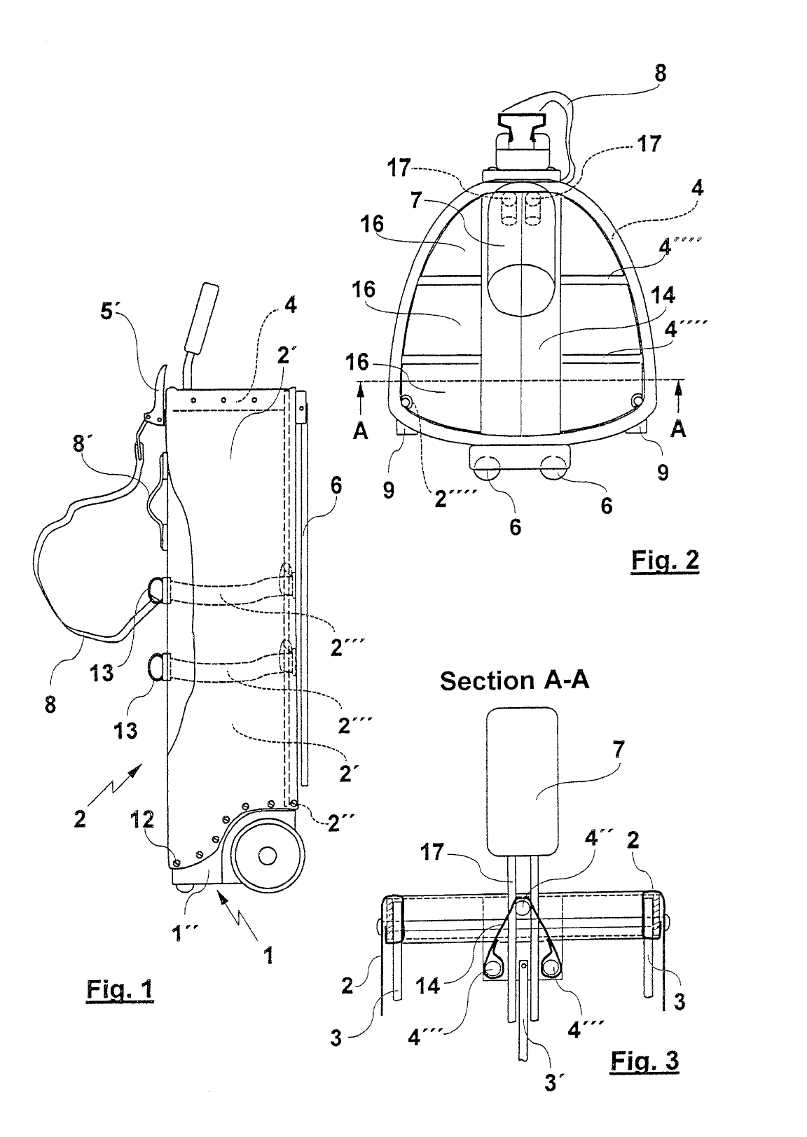

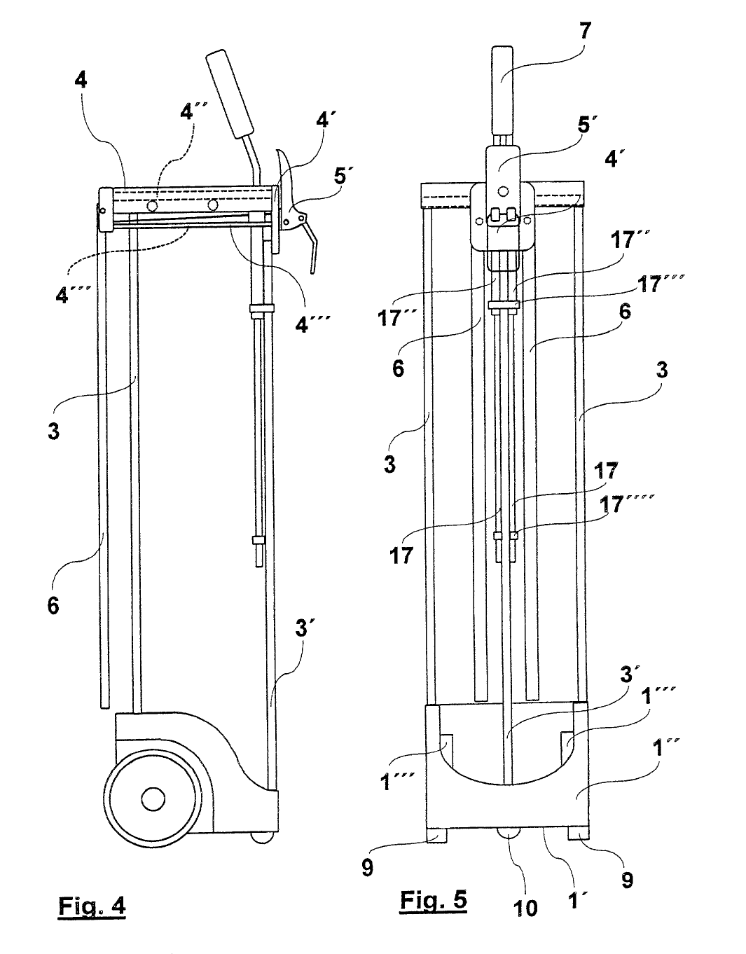

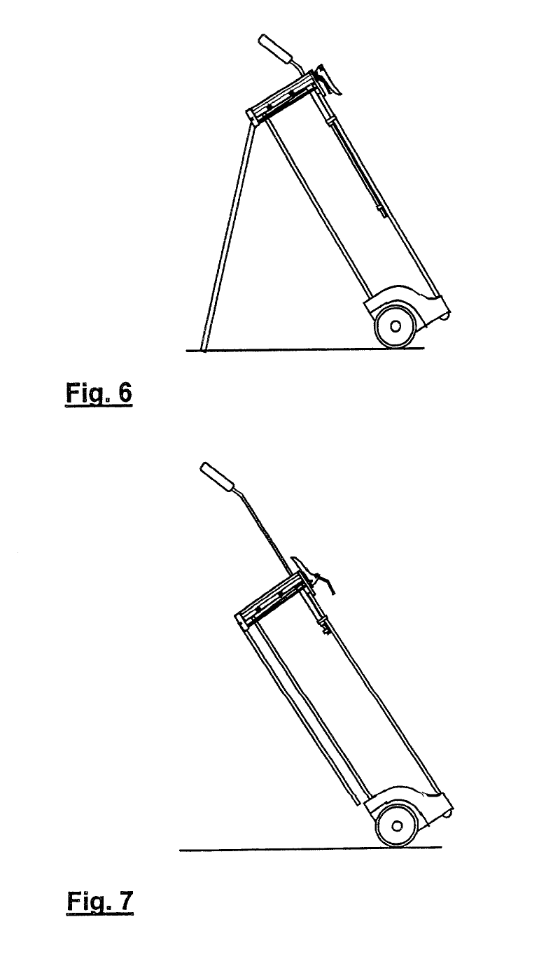

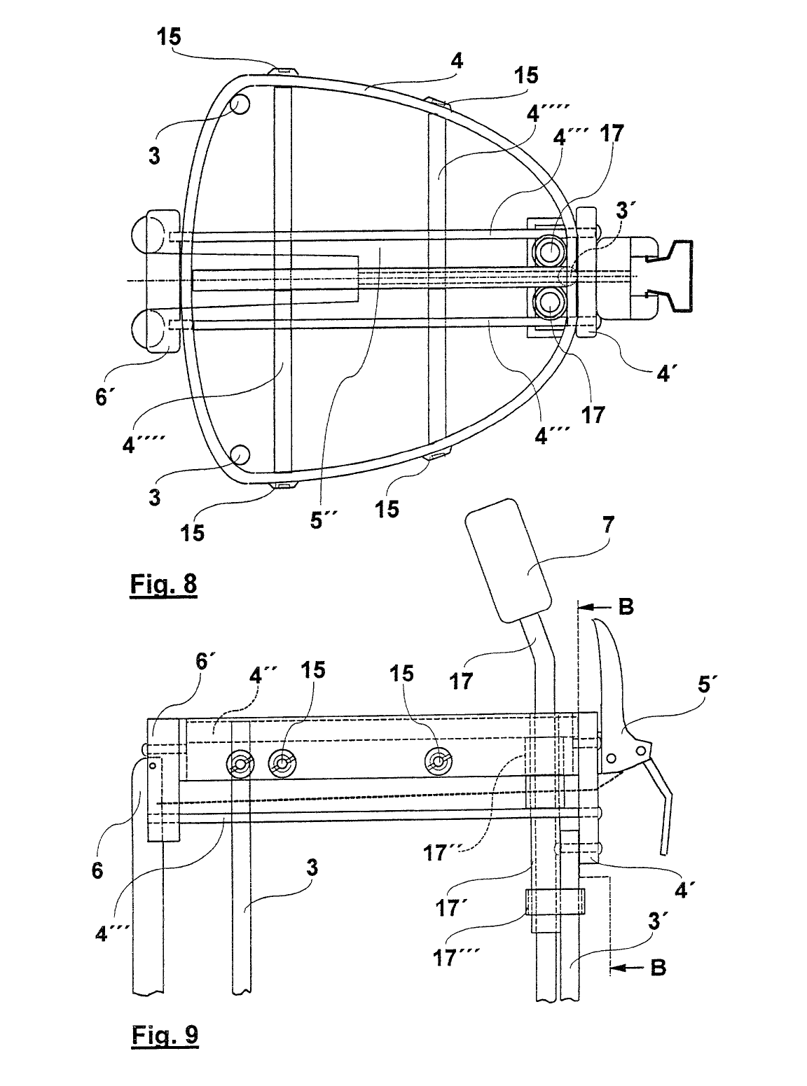

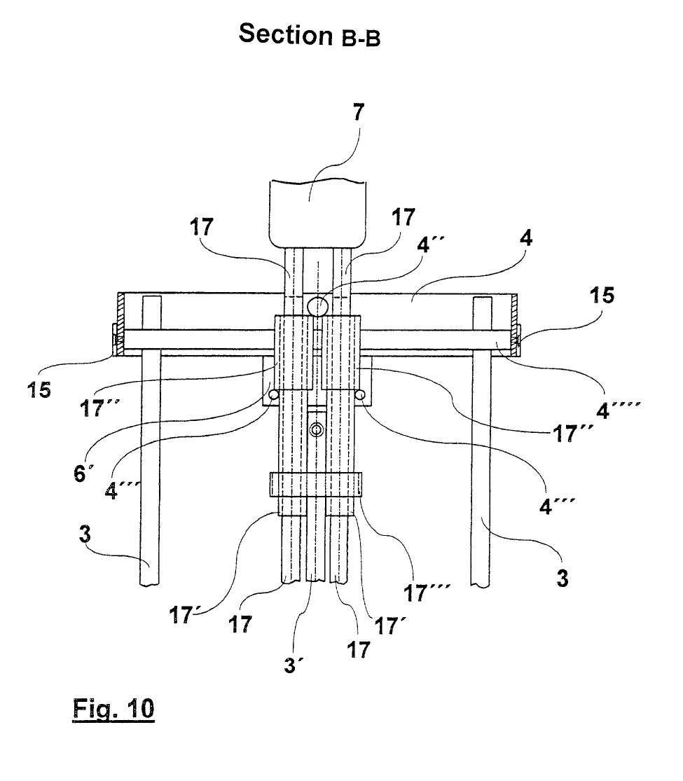

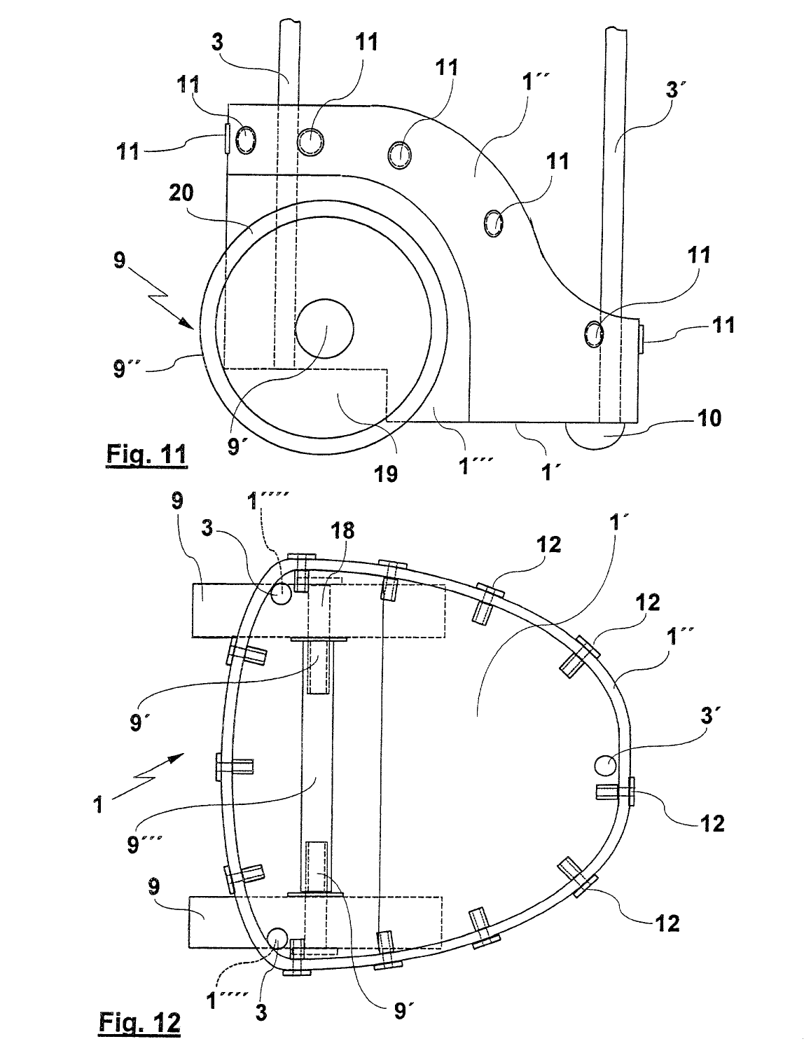

Referring to the drawings in particular, the complete golf bag according to the present invention is shown in greater detail in FIG. 1 through FIG. 3 and comprises in this exemplary embodiment a bottom part 1 with wheels 9 and support foot 10, a cylinder part 2 with stabilizing longitudinal webs 3 and 3′ as well as a belt system 8, a head part 4 with a mounting surface 4′, stabilizing webs 4″ and 4′″ and webs 4″″ as well as a bracket 6′ with a support device 5 and support legs 6 as well as a sloped pull-out grip 7. According to FIG. 11 and FIG. 12, the bottom part 1 is preferably an approximately trapezoidal one-piece injection-molded or deep-drawn part manufactured from plastic. The base 1′ of the bottom part 1 has dimensions of about 200 mm in length and has a width of 190 mm on one broad side and about 70 mm on the opposite broad side and its vertical jacket surface 1″ is made in one piece preferably on the narrow broad side at a level of 50 mm and at a level of 150 mm on the opposite broad side. A wheel case 1′″, protruding into the bottom part 1, with the dimensions of, e.g., 120 mm in length, 140 mm in width and 40 mm in depth, is integrated in the oblique areas of the jacket surface 1″ of the trapezoidal bottom part 1 which can be recognized in greater detail in FIG. 12. A wheel axle 9′ with a diameter of preferably 10 mm of a commercially available wheel 9 with a preferable external diameter of 120 mm passes through the jacket surface 1″ of the bottom part 1 at each wheel case 1′″ and is mounted there such that the wheel axles 9′ do not cross the center of the base 1′. In the exemplary embodiment, the wheel axles 9′ are additionally held in a continuous axle sleeve 9′″, which does not co-rotate, in order to relieve the jacket surface in the wheel cases 1′″. The wheels 9, which preferably have a width of 30 mm, are provided, e.g., with a tread 9″ consisting of hard rubber, which has a low degree of wear. The wheel axles 9′ are arranged according to FIG. 11 such that the treads 9″ of the wheels 9 project beyond the base 1′ and beyond the jacket surface 1″ on the 190-mm broad side by preferably 15 mm each. Moreover, the wheels 9 are equipped with a ball bearing 18 and thread guard 19, which brings about the good ability of the wheels to run and protects the wheel axles from contamination. The base 1′ has, e.g., a step of a height of preferably 10 mm extending vertically to the longitudinal axis of the golf bag in order to guarantee the tiltability of the golf bag and the necessary ground clearance of the bottom part 1. This step is compensated with a support foot 10 made in one piece with the outer base 1′ for the good vertical stability of the golf bag. For example, two longitudinal webs 3 and a longitudinal web 3′, which are preferably hollow sections made of aluminum, are arranged vertically detachably on the inner base 1′ of the bottom part 1 at the fixing points 1″″, the longitudinal web 3′ being reinforced by an additional inner tube made of carbon. Mounting openings 11, which are preferably provided with threaded sleeves, via which the cylinder part 2 is screwed to the bottom part 1, are arranged at the open edge of the jacket surface 1″. The cylinder part 2 is a part made preferably from a stable plastic, which additionally connects the individual components of the frame of the golf bag to one another and covers them according to FIG. 1 On the front sides of its jacket surface 2′, it is connected by means of mounting openings 2″ to the bottom part 1, on the one hand, and to the head part 4 by fastening elements 12, such as screws, on the other hand. It is, of course, also possible to connect the parts by means of rivets, but this makes it difficult to repair or replace individual parts. The longitudinal webs 3 are guided inside the cylinder part 2 by the loops 2″″ of the stabilizing strips 2′″ arranged coaxially on the inner jacket surface 2′. The cylinder part 2 is wound around the material band according to FIG. 3 before being fastened to the head part 4 and is fastened with screws, as a result of which the material band of the head part 4 is covered and a load-bearing and stable connection of the cylinder part 2 to the head part 4 is ensured at the same time. Rings 13, which are used to alternatingly receive one end of the belt system 8, are arranged on the stabilizing strips 2′″ on the outer jacket surface 2′ of the cylinder part 2. In addition, a grip 8′ and the rings 13 are arranged such that they extend in the direction of the longitudinal axis of the golf bag above the longitudinal web 3′. Another end of the belt system 8 is preferably fastened to a stable metal loop of a toggle lever mechanism 5′ of the support device 5 in order for the support legs 6 to fold in automatically when the golf bag is lifted by the belt system 8. The head part 4 according to the present invention comprises, according to FIGS. 8 through 10, a metal band of a width of preferably 30 mm and preferably has, according to FIG. 8, like the bottom part 1, an approximately trapezoidal shape. A mounting surface 4′ made preferably of plastic, which extends axially in relation to the longitudinal axis and in the direction of the bottom part 1 of the golf bag, is screwed to the narrow outer surface of the metal band. A bracket 6′ for the support feet 6 is screwed on on the opposite side on the broad side of the metal band. A web 4″ consisting of a hollow section is screwed on centrally between the mounting surface 4′ and the bracket 6′ on both sides on the front side of the metal band, which front side is used as the opening of the golf bag, to stabilize the metal band and consequently the head part 4. According to FIG. 9, two additional webs 4′″ consisting of a hollow section are screwed to the lower edge of the mounting surface 4′, on the one hand, and to the bracket 6′ of the support legs 6, on the other hand, under and on both sides of the web 4″. According to FIG. 2, the webs 4′″ form with the web 4″ a hollow space open on all sides, in which the clamping system 5″ of the support device 5, not shown in detail, extends. As is shown more specifically in FIG. 2, the webs 4″ and 4′″ as well as the clamping system 5″ are closed and covered with a piece of material 14 preferably consisting of leather, with two opposite edges of the piece of material 14 being wound around the webs 4′″ and are detachably fastened by means of, e.g., a VELCRO strip (hook and loop fastener strip). The webs 4″″ screwed to the metal band of the head part 4 at right angles to the webs 4″ and 4′″ are likewise hollow sections to form compartments 16, on the one hand, and are screwed on with screws 15 to additionally stabilize the material band of the head part 4, on the other hand. For example, screws whose heads form the base part of a snap fastener were selected for this purpose in order to button to these, e.g., a cover hood, with which the golf bag with the golf clubs protruding from it can be closed after the end of the game. The support legs 6 are arranged movably on the bracket 6′ and are connected to the toggle lever mechanism 5′ arranged on the outer mounting surface via the clamping system 5″. According to FIG. 10, the free ends of the longitudinal webs 3 are screwed to the metal band of the head part 4, the longitudinal web 3′ is made somewhat shorter because of limited space and is connected to the mounting surface 4′. FIG. 8, FIG. 9 and FIG. 10 show the arrangement of the grip 7 with its double tube system in greater detail. According to FIG. 10, the grip 7 is arranged on the inside of the mounting surface 4′, and the two tubes 17 of the grip 7 are mounted movably in a sleeve 17′ each, and the sleeves 17′ are held in a sleeve 17″ each between the webs 4′″ and 4″. A fixer 17′″ each, with which the ends of the sleeves 17′ are locked at the longitudinal web 3′, is arranged at the ends of the sleeves 17′. The ends of the tubes 17 are guided vertically movably at the longitudinal web 3′ by a guide strap 17″″. At its end protruding from the golf bag, the grip 7 is preferably sloped by about 20% in relation to the longitudinal axis of the golf bag in order to thus guarantee better handling. FIG. 4 and FIG. 5 show a completely mounted frame of the golf bag, without the cylinder 2, i.e., without cover, for the sake of greater clarity, with the support legs 6 folded in. FIG. 6 shows the frame in a sloped position with the support legs 6 folded out and the grip 7 pushed in. FIG. 7 shows the golf bag in the rolling position with the grip 7 pulled out and the support legs 6 folded in. Finally, the golf bag according to the present invention may also be equipped only with a support system 5 and without rollable bottom part 1 in a second variant or, in a third variant, with rollable bottom part 1 and without support system 5. The use of various materials is, of course, also variable. Thus, the cylinder part may also consist of leather or nylon or another sturdy fabric.

While specific embodiments of the invention have been shown and described in detail to illustrate the application of the principles of the invention, it will be understood that the invention may be embodied otherwise without departing from such principles.

What is claimed is:

1. A golf bag comprising:
a cylinder part with stabilizing longitudinal webs;
a head part connected to said cylinder part in a repeatedly detachable manner;
a rollable bottom part connected in a repeatedly detachable manner to said cylinder;
support legs connected to said head part;
a support device with a toggle lever mechanism and a clamping system for folding out and folding in said support legs, said support device being connected to said head part;
a pull-out grip connected to said head part;
a belt system connected to said cylinder part, said bottom part being equipped with wheels and/or a said support foot for tilting, rolling and/or being put down vertically with a three-point bearing, said support device being arranged on said head part to allow the golf bag to be put down in a sloped user position by means of said toggle lever mechanism or another system with said support legs and the golf bag can be carried over the shoulder or on the back and can be put down as desired by means of the belt system, together with said rollable bottom part and said support system as well as said support legs can be folded in, in a stable manner by means of the belt mount or another release mechanism.

2. A golf bag in accordance with claim 1, wherein said bottom part is a light-weight, dimensionally stable, one-piece container with a beveled or flat base bent in a stepped pattern to the longitudinal axis of the golf bag and with a jacket surface made in one piece vertically, which has the same height or a different height in the axial direction in relation to said bottom part, wherein said support foot is arranged detachably or is made in one piece compensates the vertical position of the golf bag in the case of said base being bent in a stepped manner, said jacket surface having an essentially cylindrical shape or being equipped with two wheel cases, which are made in one piece and are directed into the said bottom part, in which two wheel bearings are arranged opposite one another and a plurality of mounting openings are arranged along the respective contour of the open front side of said jacket surface and at least three said fixing points are arranged on an inner base.

3. A golfbag in accordance with claim 2, wherein said wheels have wheel axles passing through said vertical jacket surface opposite each other in parallel from the outside and said wheel axles do not cross the center of said base, wherein said wheels extend beyond said bottom part in the case of a cylindrical jacket surface of said bottom part and are essentially covered and protected by wheel cases in the case made in one piece; said wheels having treads extending beyond said base toward the ground and beyond said jacket surface in a direction of travel, wherein said treads form a stable three-point bearing in case of a stepped base and with said support foot arranged on said base when the golf bag is standing vertically.

4. A golf bag in accordance with claim 1, wherein said cylinder part is formed of a flexible and stable material and is equipped on both open front sides of a jacket surface of said cylinder part with a plurality of mounting openings, said mounting openings being connected in a repeatedly detachable manner to a jacket surface of said bottom part and to said head part by means of fastening elements, wherein said cylinder part is wound around said head part from an outside to an inside before it is fastened to said head part, one or more stabilizing strips of a flexible material which form loops are arranged coaxially and in a non-positive manner on an interior of said jacket surface of said cylinder part, said belt system extending axially above said longitudinal web, and a grip arranged on said outer jacket surface of said cylinder part, and said rings are arranged in an area of said stabilizing strips.

5. A golf bag in accordance with claim 1, wherein said stabilizing longitudinal webs each include a lightweight hollow section detachably connected to said fixing points of an inner base of said bottom part and to said head part, wherein said longitudinal webs are guided by loops of said cylinder part, each said longitudinal web being reinforced by an additional inner tube with ends of said longitudinal webs located opposite said bottom part arranged detachably directly at said head part and with each said longitudinal web being arranged detachably at said head part via a mounting surface.

6. A golf bag in accordance with claim 1, wherein said head part is a closed band material, on the outside of said closed band material a mounting surface and a bracket are arranged opposite each other and are directed axially to said bottom part, an open front surface of said head part being stabilized by a web and two additional webs are arranged at said inner mounting surface and at said bracket and at equally spaced locations next to said web, wherein said web and said additional webs form a triangular hollow space open on all sides.

7. A golfbag in accordance with claim 6, wherein said toggle lever mechanism of said support device has said clamping system extending in the triangular hollow space formed by said web and said additional webs and is connected to said support legs arranged at the outer jacket surface of said head part against said mounting surface arranged at said outer mounting surface, wherein said movable clamping system is protected by said web and said additional webs and said clamping system are covered with a flexible piece of material and two opposite edges of said piece of material are detachably fastened under said two additional webs.

8. A golf bag in accordance with claim 6, wherein at least two further webs extend in parallel to one another and are detachably connected to said head part by screws on both sides and are arranged at right angles to said web and said additional webs, wherein said further webs form compartments for the golf clubs and the heads of said screws are base parts of snap fasteners.

9. A golfbag in accordance with claim 1, wherein said pull-out grip comprises a double tube system, in which two said tubes are arranged in parallel in a grip part and are sloped to the longitudinal axis of the golf bag at the end of the grip, wherein the non-sloped tube ends are guided in a sleeve each at said reinforced longitudinal web and are held by said sleeves arranged vertically between said web and said additional webs, a fixer and a guide strap, and said grip can be pulled out beyond the center of gravity of the golf clubs being stored in the golf bag in the direction of the longitudinal axis of the golf bag.

10. A golf bag in accordance with claim 1, wherein said belt system is alternatingly connected with one end to a ring of said cylinder part and with another end to said toggle lever system of said support device at said head part, wherein said folded-out support legs are folded in by means of said clamping system when the golfbag is lifted by said belt system and the golf bag can be carried, and wherein the acting forces are distributed between said two longitudinal webs during the lifting of the golf bag via loops of said cylinder part.
